(19) United States
(12) Patent Application Publication
(10) Pub. No.: US 2011/0163127 A1
(43) Pub. Date: Jul. 7, 2011

(54) BEVERAGE APPARATUS FOR PREPARING, STORING, AND DISPENSING INFANT FORMULA

(76) Inventor: Danielle DiBella-Lenaway, Alpharetta, GA (US)

(21) Appl. No.: 12/196,403

(22) Filed: Aug. 22, 2008

Related U.S. Application Data
(60) Provisional application No. 60/957,437, filed on Aug. 22, 2007.

(51) Int. Cl. B67D 7/74

(52) U.S. Cl. 222/145.6; 222/146.1

(57) ABSTRACT

A beverage apparatus includes a mixing chamber that is configured to control the temperature of infant formula and to agitate infant formula, a powder compartment, and a liquid reservoir. The powder compartment includes a dispensing apparatus that is configured to dispense a measured amount of powder into the mixing chamber and the liquid reservoir includes a valve that is configured to dispense a measured amount of liquid from the liquid reservoir into the mixing chamber. The mixing chamber includes a temperature control element that permits the formula to be stored in a heated state for shorter time periods and in a refrigerated state for longer time periods.

### CROSS REFERENCE TO RELATED APPLICATIONS

This application claims priority to U.S. Provisional Application No. 60/957,437, filed Aug. 22, 2007, the entirety of which is incorporated herein by reference.

### TECHNICAL FIELD

This invention relates generally to beverage apparatuses for processing ingredients and, more specifically, to beverage apparatuses for preparing, storing, and dispensing a mixture such as infant formula.

### BACKGROUND

Preparing infant formula can be a difficult task. Certain machines prepare infant formula by combining formula mix and water in a bottle or by directly dispensing a mixture of formula mix and water into a bottle. Where formula mix and water are combined in a bottle, the user may have to manually measure the amount of formula mix that is needed. This is time consuming and risks human error when measuring the formula mix. Further, as the formula mix and water are mixed, the temperature of the infant formula is typically not controlled in the bottle and the user must take care to ensure that the infant formula does not spoil.

It is also important to prepare the infant formula at a desired consistency. Where infant formula is prepared in a bottle, it can be difficult to agitate the infant formula to get the desired consistency or a specialized bottle may be required to get the desired consistency. Similarly, formula mix and water that are combined but not agitated just before dispensing into a bottle may not provide formula that has the desired consistency.

In addition, in many situations, infant formula that is prepared may not be able to be used until a later time. Such infant formula may go bad before the time that it can be used and have to be discarded because baby formula requires special conditions to be preserved.

There is an unaddressed need in the industry to address these and other deficiencies and inadequacies.

### SUMMARY

The various embodiments of the present invention overcome the shortcomings of the prior art by providing an apparatus that prepares, stores, and dispenses a mixture, such as infant formula. Specifically, the apparatus is capable of accurately combining a measured amount of water and a measured amount of formula mix to consistently produce quality infant formula, agitating the infant formula to a quality consistency, storing a infant formula at a heated or refrigerated temperature, heating the infant formula from a refrigerated or relatively low temperature, and dispensing all or part of the infant formula at a desired temperature.

Although the mixture of ingredients will be described herein as infant formula for purposes of teaching, those skilled in the art will appreciate that other mixtures can be prepared using an apparatus taught by the present disclosure.

The disclosure is directed to embodiments of an apparatus that simply, conveniently, and automatically prepares infant formula. The apparatus prepares the infant formula in accordance with standard or user-defined instructions, measures and combines the proper ratio of formula mix and water, stores the infant formula at the appropriate temperature, and dispenses the infant formula on demand for infant feedings.

According to an exemplary embodiment, a beverage apparatus includes a mixing chamber that is configured to control the temperature of infant formula, a powder compartment that includes a dispensing apparatus that is configured to dispense a measured amount of powder into the mixing chamber, and a liquid reservoir that includes a valve that is configured to dispense a measured amount of water into the mixing chamber. The dispensing apparatus and the valve provide accurately measured amounts of powder and water into the mixing chamber such that the resulting formula has the proper ratio of ingredients. A controller is configured to control the operation of the dispensing apparatus and the valve.

According to an exemplary embodiment, the dispensing apparatus includes a scoop with a void that is configured to receive a volume of powder. The scoop void can move between an opening in the powder compartment and an opening in the mixing chamber. The dispensing apparatus can further include an arm positioned in the powder compartment that moves powder through the powder compartment opening and into the scoop void and a cam that positions the scoop void.

The mixing chamber is configured to agitate the infant formula and to control the temperature of the infant formula such that the infant formula has a desired consistency. According to an exemplary embodiment, an agitator includes a blade that is magnetically coupled to a motor and the mixing chamber further includes a temperature control element and a temperature sensor. The temperature control element can transfer heat to or from the mixing chamber depending on preparation instructions and input from the temperature sensor. Operation of the agitator and the temperature control element can be controlled by a controller and the temperature sensor can be an input to the controller. The desired consistency of the infant formula can be achieved through variables such as agitation time, agitation speed, and temperature during agitation.

Once the infant formula has been prepared, the infant formula can be dispensed or stored. The temperature control element can be operated to bring the infant formula to a feeding temperature for immediate dispensing, can warm and store the infant formula for dispensing and feeding within a shorter time period, and can refrigerate and store the infant formula for dispensing and feeding within a longer time period.

According to an exemplary embodiment, the beverage apparatus includes a sleeve that is configured to receive a bottle and that includes a temperature control element. The sleeve permits infant formula that has been dispensed into a bottle to be maintained at a feeding temperature or stored at a controlled temperature as is described with respect to the mixing chamber.

The beverage apparatus can further include a partitioning chamber with a temperature control element. The mixing chamber can feed into the partitioning chamber. Accordingly, a portion of refrigerated infant formula that is stored in the mixing chamber can be moved to the partitioning chamber and heated to a feeding temperature before dispensing from the partitioning chamber.

According to an exemplary embodiment, the beverage apparatus is a countertop appliance that incorporates any or all of the functions described above. In addition, the apparatus can include one or more modular components that can interface or dock with the countertop appliance. Certain embodiments or modular components of the beverage apparatus can be entirely portable. For example, a main unit can include the liquid compartment and the powder compartment and a modular unit can include the mixing chamber with the agitator and temperature control element.

The foregoing has broadly outlined some of the aspects and features of the present invention, which should be construed to be merely illustrative of various potential applications of the invention. Other beneficial results can be obtained by applying the disclosed information in a different manner or by combining various aspects of the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is a schematically-illustrated view of a beverage apparatus according to a first exemplary embodiment of the present disclosure.

FIGS. 2 and 3 are cross sectional side elevation views of a dispensing apparatus of the beverage apparatus of FIG. 1.

FIG. 4 is a partial perspective view of an alternative dispensing apparatus.

FIG. 5 is a diagram of a control system of the beverage apparatus of FIG. 1.

FIG. 6 is a perspective view of a beverage apparatus, according to a second exemplary embodiment of the present disclosure.

FIG. 7 is a schematically-illustrated view of the beverage apparatus of FIG. 6.

FIG. 8 is a perspective view of a beverage apparatus, according to a third exemplary embodiment of the present disclosure.

FIG. 9 is a partial schematically-illustrated perspective view of a beverage apparatus, according to a fourth exemplary embodiment of the disclosure.

### DETAILED DESCRIPTION OF THE INVENTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

The embodiments of the present invention are illustrated in the context of a beverage apparatus that is adapted to prepare infant formula at a temperature and consistency that is suitable for feeding an infant. However, it should be understood that the beverage apparatus can be used to prepare other mixtures or products such as hot chocolate, coffee, and the like. In the embodiments illustrated and described herein, the infant formula is prepared by mixing water and dry powder. In alternative embodiments, the infant formula can be prepared by mixing any combination of substances, such as but not limited to water, powdered formula, liquid formula, formula concentrate, milk, solute, a solution, a suspension, a colloidal dispersion, other substances that are combined with liquid to form a mixture, combinations thereof, and the like.

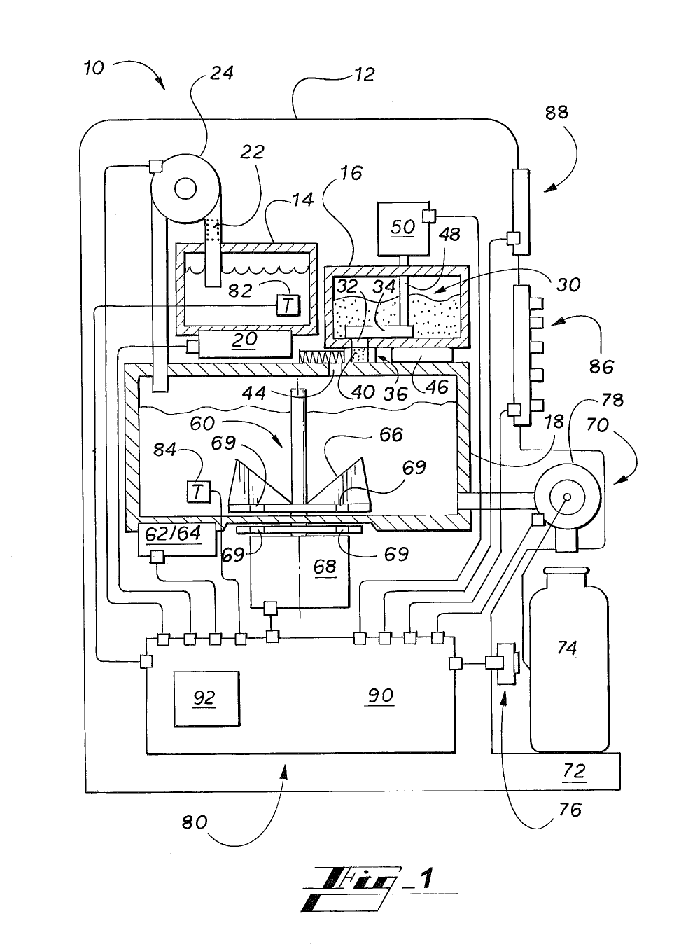

For purposes of teaching the various aspects of the invention, several non-limiting embodiments will be described as examples of implementations of the invention. Referring now to FIGS. 1-5, the drawings illustrate a beverage apparatus 10. Referring to FIG. 1, the beverage apparatus 10 includes a housing 12 that encloses internal system elements. The internal system elements include those that cooperatively or individually measure and combine an amount of liquid and an amount of powder, agitate the liquid and the powder to produce infant formula, store the infant formula at a heated or refrigerated temperature, heat the infant formula from a refrigerated or relatively low temperature, and dispense all or part of the infant formula at an optimal feeding temperature.

The illustrated beverage apparatus 10 includes a reservoir 14 for storing a volume of water and a powder compartment 16 for storing an amount of powder. Both the reservoir 14 and the powder compartment 16 feed into a mixing chamber 18. The reservoir 14 is heated by a water heater 20 and a filter 22 is located between the reservoir 14 and the mixing chamber 18. Each of the water heater 20 and the filter 22 facilitate removing contaminants from the water entering the mixing chamber 18. For example, the water can be boiled with the water heater 20 to kill parasites and bacteria and the filter 22 can be a screen filter or a reverse osmosis filter that removes contaminants such as chemicals or particulates. In alternative embodiments, the reservoir 14 can be omitted and a user can pour water directly into the mixing chamber 18 through the filter 22. A liquid dispensing apparatus controls flow from the reservoir 14 to the mixing chamber 18. The illustrated liquid dispensing apparatus is a pump 24 although in other embodiments the liquid dispensing apparatus can be a valve with mechanically controllable mechanisms.

The powder compartment 16 includes a dispensing apparatus 30 that measures and dispenses powder from the powder compartment 16 into the mixing chamber 18. A powder compartment opening 32 is positioned at the bottom of the powder compartment 16. The illustrated dispensing apparatus 30 includes a rotating wiper arm 34 that directs powder into the powder compartment opening 32, and a scoop 36 with a body 38 and a scoop void 40 that extends through the body 38. The scoop void 40 can be positioned to align with the powder compartment opening 32 as well as with a mixing chamber opening 44. The scoop 36 includes a spring 42 that forces the body 38 against a cam 46 to facilitate positioning the scoop 36. In alternative embodiments, the powder compartment dispensing apparatus can include an auger.

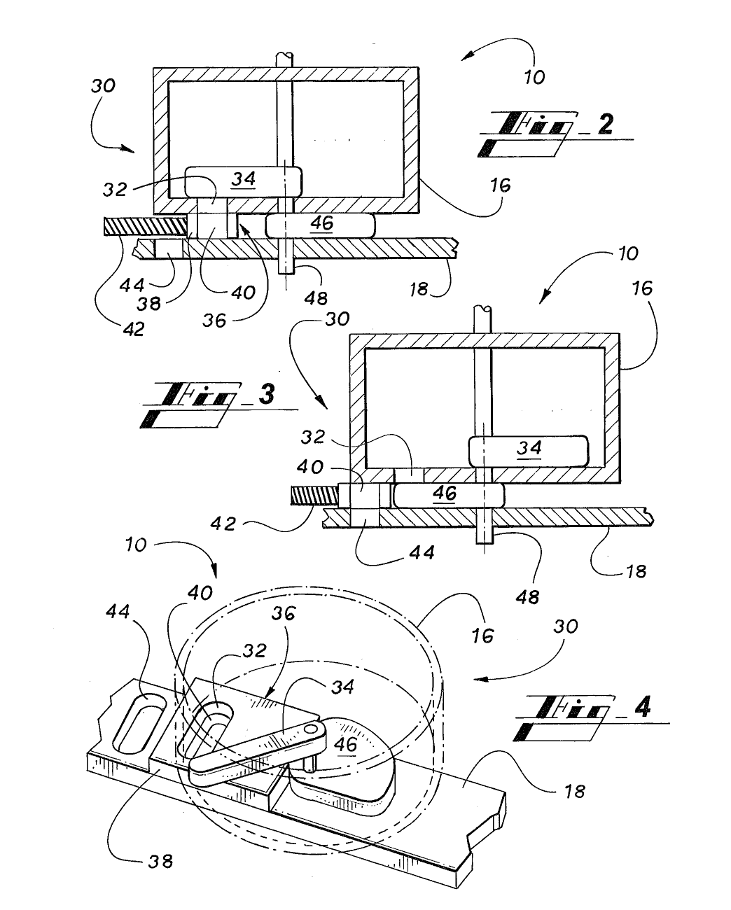

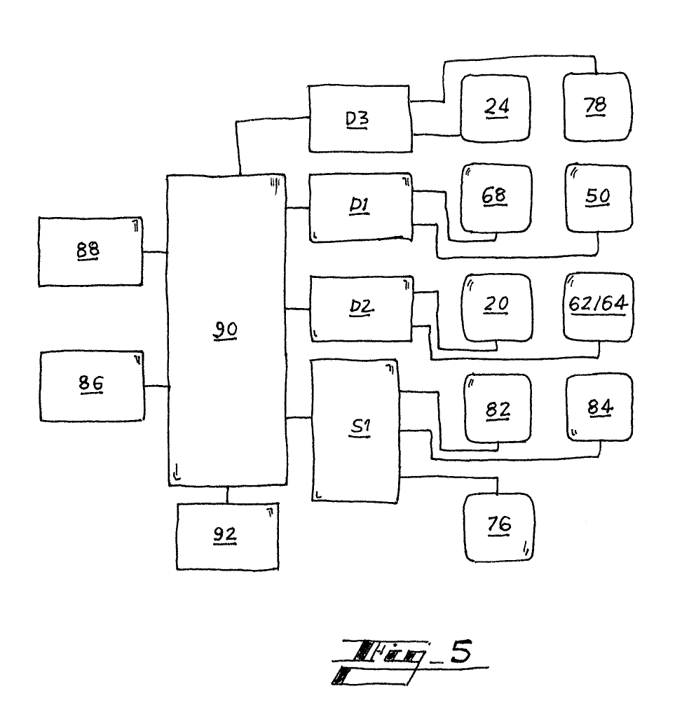

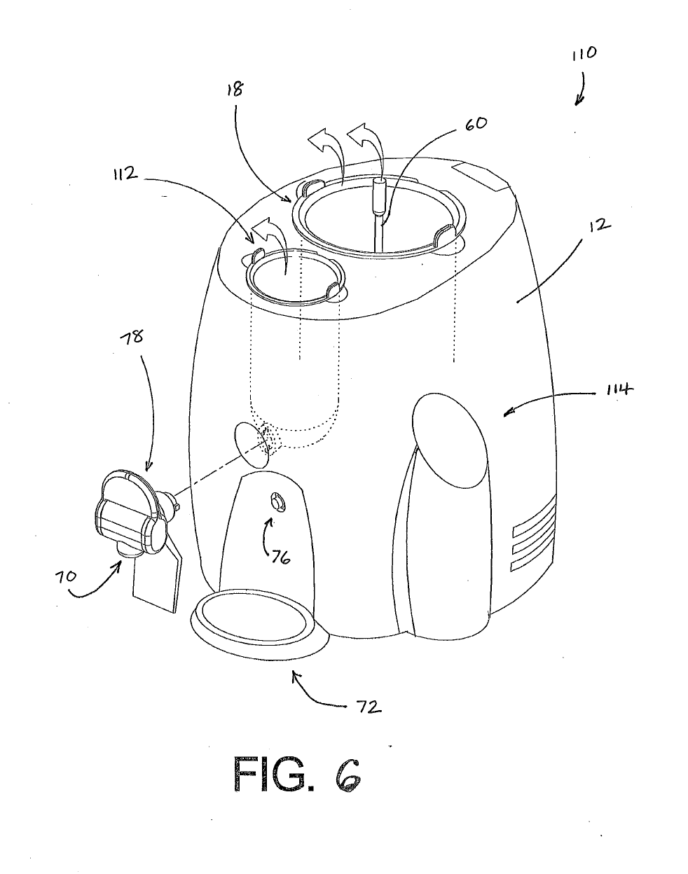

The wiper arm 34 and a cam 46 are attached to a shaft 48. A dispensing apparatus motor 50 rotates the shaft 48 to move the cam 46 and the wiper arm 34. During a portion of the rotation of the shaft 48, the scoop void 40 is aligned with the powder compartment opening 32 and the wiper arm 34 moves powder through the powder compartment opening 32 and into the scoop 36. During another portion of the rotation of the shaft 48, the cam 46 pushes the scoop void 40 out of alignment with the powder compartment opening 32 and into alignment with the mixing chamber opening 44 and the powder is dropped from the scoop 36 into the mixing chamber 18. In the embodiment shown in FIGS. 2 and 3, the cam 46 blocks the powder compartment opening 32 when the scoop 36 is not positioned to be filled with powder. In the embodiment shown in FIG. 4, the body 38 of the scoop 36 blocks the powder compartment opening 32 when the scoop 36 is not positioned to be filled.

The dispensing apparatus 30 can repeat this measuring and dispensing process to drop a certain number of measured amounts into the mixing chamber 18. The number of measured amounts that are used can depend on the amount of formula to be prepared and the volume of the scoop void 40.

Referring to FIG. 1, the mixing chamber 18 includes an agitator 60 and a temperature control element 62/64 that includes a heating element 62 and a cooling element 64. The agitator 60 includes a blade 66 that is magnetically coupled to an agitator motor 68 by a magnet arrangement 69. By magnetically coupling the blade 66 to the agitator motor 68, the blade 66 can be positioned inside the mixing chamber 18 and the agitator motor 68 can be positioned outside the mixing chamber 18. Since there is no direct connection between the blade 66 and the agitator motor 68, the blade 66 can be easily removed from the mixing chamber 18, for example, for purposes of cleaning.

The heating element 62 and the cooling element 64 are temperature control elements that respectively heat and refrigerate infant formula that is in the mixing chamber 18. For example, the temperature control element 62/64 can be a thermoelectric heat pump such as a Peltier device.

The beverage apparatus 10 is configured to prepare multiple servings of infant formula at once, to dispense one or more of the servings upon demand, and to store the remainder of the servings for the next dispensing event. Continuing with FIG. 1, in the first exemplary embodiment, a spout 70 extends from the mixing chamber 18 to a dispensing area 72. A bottle 74 can sit in the dispensing area 72 and contact a dispensing button 76 that opens a valve 78. The valve 78 controls flow from the mixing chamber 18 through the spout 70. In alternative embodiments, the valve 78 can be substituted with a pump.

Referring to FIGS. 1 and 5, the beverage apparatus 10 includes a control system 80 for controlling the operation of mechanical and thermal elements. For example, the pump 24 or valve that controls flow from the reservoir 14 to the mixing chamber 18, the dispensing apparatus motor 50, the agitator motor 68, the water heater 20, the heating element 62, and the cooling element 64, and the valve 78 or pump that controls flow from the mixing chamber 18 through the spout 70 can be individually and/or synchronously controlled by the control system 80. The control system 80 also includes temperature sensors 82, 84 that are respectively located in the reservoir 14 and the mixing chamber 18, a program keyboard 86 where a user can enter commands, and a visual information display 88. Elements that are linked to or part of the control system 80 are connected to a controller 90. The controller 90 coordinates the operation of the mechanical and thermal elements based on user input, input from the temperature sensors, and commands from a computer program. An operator parameter memory 92 can store computer programs.

Referring to FIG. 5, the illustrated control system 80 includes drivers D1, D2, D3 and a sensor interface S1 that respectively permit mechanical elements, thermal elements, and thermal sensors to be operated by or communicate with the controller 90. Driver D1 is a motor control driver, driver D2 is a temperature control driver, driver D3 is a pump or valve mechanism driver, and sensor interface S1 interfaces with sensors that provide input to the controller 90.

The illustrated control system 80 includes an interface (program keyboard 86 and visual information display 88) for the user to direct the operation of the beverage apparatus 10. In alternative embodiments, the user interface may include any suitable input/output (I/O) devices and mechanisms such as but not limited to touch pads, touch screens, push buttons, switches, keypads, mice, joysticks, and the like. The I/O devices translate user interaction into instructions for a processor (not shown) that controls the operation of the components described above. The processor may directly execute the instructions or may respond by launching predefined programs that correspond to the user interaction. The control system may further include a memory that stores the executable instructions that make up the predefined programs.

For example, one predefined program may receive as user input a desired amount of formula to dispense. The user may provide this input by pressing a button that corresponds to one of several common feeding volumes, such as four ounces, six ounces, and eight ounces. In response to receiving this input, the control system 80 can direct the beverage apparatus 10 to prepare and dispense the selected volume of infant formula. Other examples of user input provided via the I/O device include time parameters, infant formula proportions, optimal temperature settings, and input that identifies the type of infant formula that is being prepared. It may be desirable, for example to inform the apparatus that the infant formula will be viscous or that the user wishes to alter the proportion of liquid to powder.

A non-limiting method of operating the beverage apparatus 10 is now described. Commands are entered with the program keyboard 86. The entered information can include the amount of formula to be prepared and the desired time of availability. The controller 90 transfers the information to the operator parameter memory 92 and prompts a user to enter a start command with the visual information display 88. Once the user enters a start command, the controller 90 initiates a software program to initiate operation of the water heater 20, temperature control element 62/64, dispensing apparatus motor 50, and agitator motor 68 in a sequence. The controller 90 operates the water heater 20 to boil the water in the reservoir 14 and then operates the pump 24 to pump a selected amount of water from the reservoir 14 into the mixing chamber 18. The controller 90 operates the dispensing apparatus 30 to measure and dispense a selected amount of powder from the powder compartment 16 into the mixing chamber 18, as described above.

The powder and the heated water are agitated in the mixing chamber 18 by the agitator 60 for a selected amount of time. The heating element 62 and associated temperature sensor 84 allow the temperature of the infant formula to be controlled during the agitation operation. A feeding bottle 74 can then be placed into the dispensing area 72 where the dispensing button 76, or a proximity sensor or a contact sensor, alerts the controller 90 that the bottle 74 is positioned to receive part or all of the infant formula. The controller 90 responds by operating the valve 78 or pump or formula release gate to open and release an amount of formula into the feeding bottle 74.

Once the infant formula is initially prepared in the mixing chamber 18, the beverage apparatus 10 provides several options for continued processing of the infant formula. As described above, first option is to immediately dispense all or part of the infant formula. The heating element 62 and temperature sensor 84 cause the temperature of the infant formula to be maintained at a feeding temperature prior to dispensing. Once the infant formula is at the feeding temperature, the valve 78 is controlled to dispense the infant formula through the spout 70 into the bottle 74. Any remaining part of the infant formula can be stored according to second or third options, as described in further detail below.

According to a second option, all or part of the infant formula is stored in the mixing chamber 18 and maintained at a selected heated temperature by the heating element 62. Thus, the infant formula is immediately or nearly ready to be dispensed at any time, but does not have to be immediately dispensed. It is contemplated that this method of storing infant formula is applicable for an intermediate period of time, for example, an hour. For storage of infant formula for an extended period of time, for example, a day, the infant formula can be stored according to a third option.

According to a third option, all or part of the infant formula is stored in the mixing chamber 18 and maintained at a selected refrigerated temperature by the cooling element 64. Refrigerating the infant formula preserves the formula until the infant formula is to be dispensed, at which time the infant formula is reheated by the heating element 62.

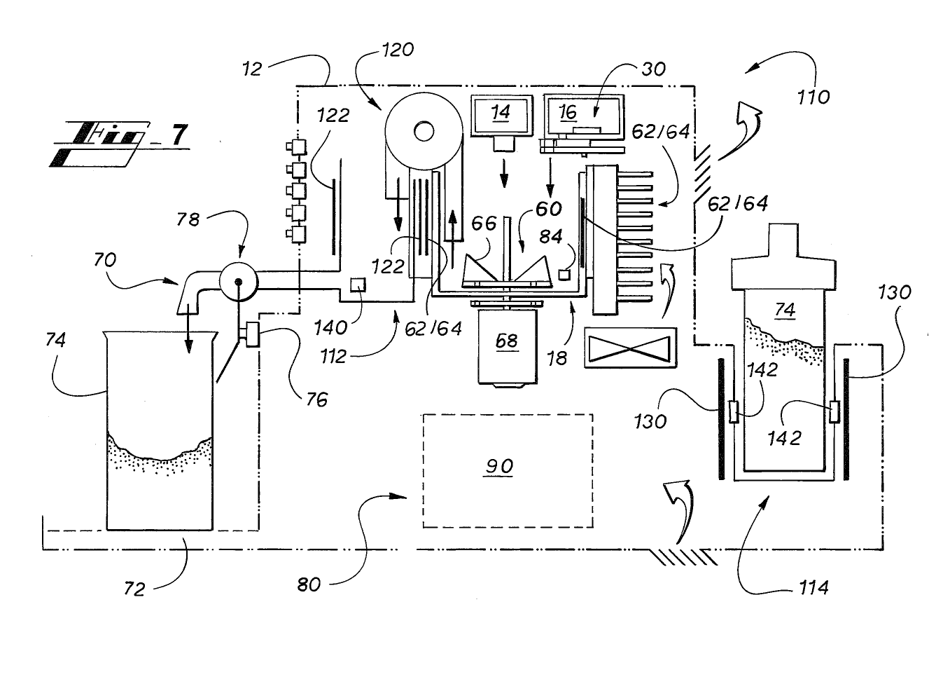

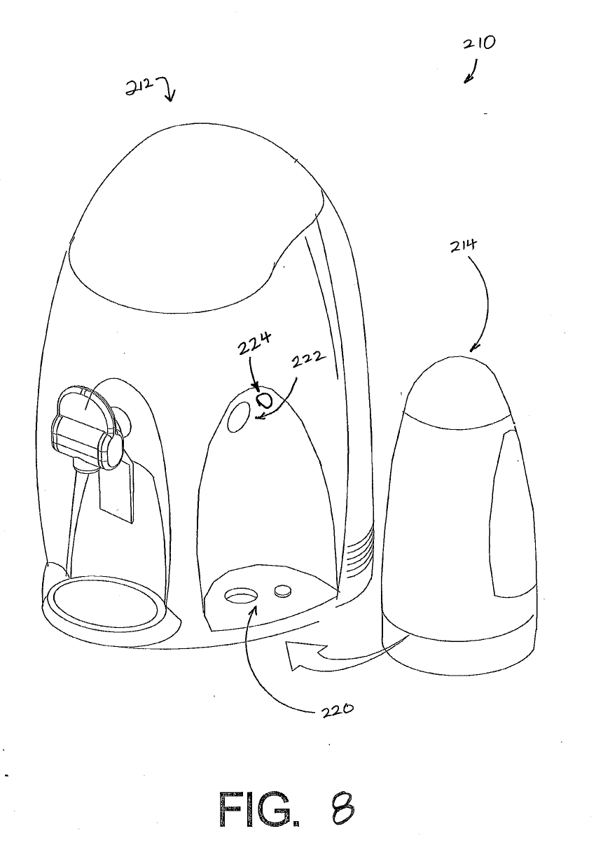

Turning to a second exemplary embodiment illustrated in FIGS. 6 and 7, a beverage apparatus 110 includes certain of the elements of the beverage apparatus 10 and further includes a partitioning chamber 112 and a temperature control sleeve 114. For clarity, elements that are substantially the same in each of the beverage apparatuses 10, 110 will be designated with the same numeral and the description of these elements will generally not be repeated except for purposes of teaching.

The partitioning chamber 112 facilitates dividing infant formula into separate portions that can be maintained at different temperatures. For example, a single serving can be taken from multiple servings of infant formula that have been stored in a refrigerated condition in the mixing chamber 18 and moved to the partitioning chamber 112 where the single serving can be heated and dispensed. A pump 120 is positioned to move all or part of infant formula from the mixing chamber 18 to the partitioning chamber 112. The partitioning chamber 112 includes a temperature control element 122 that heats the infant formula. In the illustrated embodiment, the spout 70 extends from the partitioning chamber 112. Thus, in this embodiment, the partitioning chamber 112 permits only a portion of the stored infant formula to be heated and dispensed rather than heating the entire batch of infant formula and then re-refrigerating the remaining portion of the batch that is not immediately dispensed.

The temperature control sleeve 114 is shaped to receiving a bottle 74 or container and includes a temperature control element 130 that can heat or maintain the temperature of the formula in the bottle 74. Temperature sensors 140, 142 are located in the partitioning chamber 112 and the temperature control sleeve 114, respectively, and provide input to the controller which controls the temperature control elements 122, 130.

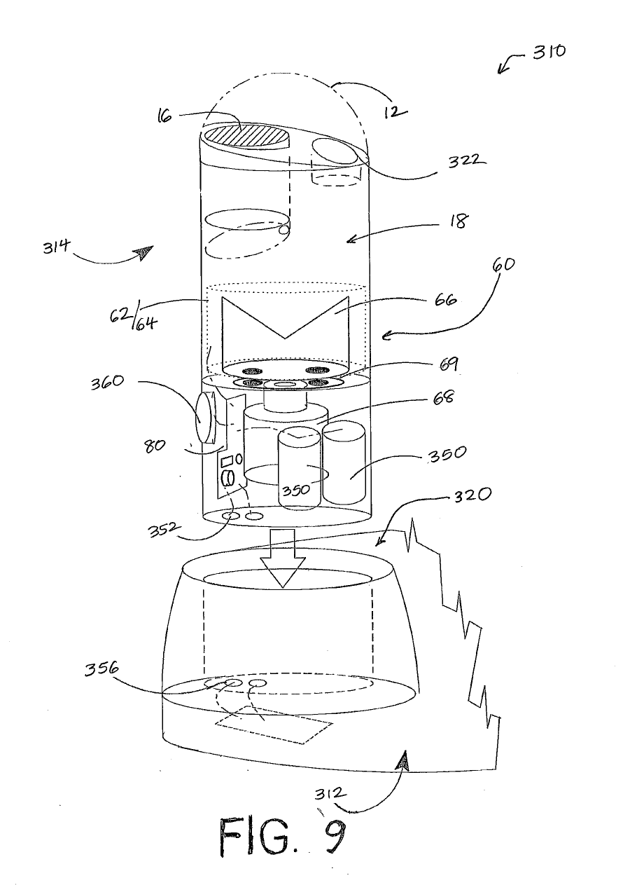

Referring to FIGS. 8 and 9, exemplary embodiments of beverage apparatuses 210, 310 with modular units are illustrated. Referring to FIG. 8, the beverage apparatus 210 includes a main unit 212 and a modular unit 214. It is envisaged that either or both of the main unit 212 and the modular unit 214 can prepare, store, and dispense formula according to the teachings described herein. Further, the main unit 212 and the modular unit 214 can include elements that work in combination. In this third exemplary embodiment, the main unit 212 has a docking area 220 where the modular unit 214 can dock. When docked or otherwise coupled with the main unit 212, the modular unit 214 can be filled with water and infant formula by the main unit 212 and powered or charged by the main unit 212. Specifically, the main unit 212 includes a reservoir (not shown) and powder compartment (not shown) and channels that lead from the reservoir and powder compartment to openings 222, 224 at the docking area 220. Alternatively, water or powder can be directly poured into the modular unit 214, as described in further detail below. In this embodiment, the modular unit 214 can include a mixing chamber with an agitator and a temperature control element. The main unit 212 and modular unit 214 also include contacts to power the modular unit 214 when docked.

Referring now to FIG. 9, another exemplary embodiment of a beverage apparatus 310 that includes a modular unit 314 and a main unit 312 with a docking area 320 is illustrated. The modular unit 314 includes a housing 12 having an opening 322 or channel that leads to a mixing chamber 18 and a powder compartment 16 or channel that opens to the mixing chamber 18. As previously mentioned, it is contemplated that the modular unit 314 can dock with a main unit such as the main unit 212. Here, the opening 322 and powder compartment 16 can be configured to interface with the openings 222, 224.

Continuing with FIG. 9, the mixing chamber 18 includes an agitator 60 and a temperature control element 62/64 that can be a heating element and cooling element. The agitator 60 includes a blade 66 and an agitator motor 68 that are magnetically coupled to one another with a magnet arrangement 69. The agitator motor 68 and heating element 62 are powered by battery cells 350 when undocked and by power supplied through contacts 352 when docked. Specifically, the docking area 320 includes contacts 356 that interface with contacts 352 to provide power and charge the battery cells 350 when the modular unit 314 is docked. The modular unit 314 includes a program keyboard 360 for operating the agitator motor 68 and heating element 62.

An exemplary method of operation of the beverage apparatus 310 is now described. The modular unit 314 is docked in the docking area 320 to fill the mixing chamber 18 with powder and water and to charge the battery cells 350. Thereafter, the modular unit 314 is removed from the docking area 320 and can be transported and/or stored until a user or computer program instructs the modular unit 314 to prepare infant formula. A user or computer program can control the modular unit 314 to heat the water with the heating element 62, release the powder from the powder compartment 16 into the water, and power the agitator motor 68 to mix the water and powder. Thereafter, the temperature of the infant formula is controlled at a selected temperature as allowed by temperature sensors and the temperature control element 62/64 and the infant formula can then be dispensed.

In the embodiment illustrated in FIG. 9, the modular unit 314 can be manually loaded with water and powder and the main unit 312 can simply be a recharging sleeve. In such embodiments, the recharging sleeve can be adapted for use in an automobile. For example, the recharging sleeve can be adapted to plug into a car cigarette lighter.

The present invention has been illustrated in relation to a particular embodiment which is intended in all respects to be illustrative rather than restrictive. Those skilled in the art will recognize that the present invention is capable of many modifications and variations without departing from the scope of the invention. For example, as used herein, directional references such as “top”, “base”, “bottom”, “end”, “side”, “inner”, “outer”, “upper”, “middle”, “lower”, “front” and “rear” do not limit the respective walls of the apparatus to such orientation, but merely serve to distinguish elements and components from one another.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. An apparatus for preparing infant formula, comprising:
a first chamber that is configured to control the temperature of a mixture;
a first compartment comprising a first dispensing apparatus that is configured to dispense a measured amount of a first mixing ingredient from the first compartment into the first chamber; and
a liquid reservoir comprising a second dispensing apparatus that is configured to dispense a measured amount of liquid from the liquid reservoir into the first chamber.

2. The apparatus of claim 1, wherein the first chamber is configured to agitate a mixture.

3. The apparatus of claim 2, wherein the first chamber comprises an agitator comprising a blade that is magnetically coupled to a motor.

4. The apparatus of claim 1, the first chamber comprising a temperature sensor and a temperature control element.

5. The apparatus of claim 4, further comprising a controller that is configured to control the operation of at least the temperature control element, wherein the temperature sensor is an input to the controller.

6. The apparatus of claim 4, the temperature control element comprising a heating element.

7. The apparatus of claim 4, the temperature control element comprising a cooling element.

8. The apparatus of claim 1, further comprising a spout configured to dispense a mixture from the first chamber.

9. The apparatus of claim 1, the first dispensing apparatus comprising a scoop with a void configured to receive a volume of the first mixing ingredient.

10. The apparatus of claim 9, wherein the scoop void is configured to move between a first opening in the first compartment and a second opening in the first chamber.

11. The apparatus of claim 1, further comprising a partitioning chamber that is configured to receive a mixture from the first chamber, the partitioning chamber comprising a temperature control element.

12. The apparatus of claim 11, further comprising a spout configured to dispense a mixture from the partitioning chamber.

13. The apparatus of claim 1, further comprising a sleeve configured to receive a container, the sleeve comprising a temperature control element.

14. The apparatus of claim 1, the further comprising a controller configured to synchronize the operation of the first dispensing apparatus and the second dispensing apparatus.

15. The apparatus of claim 14, wherein the first chamber comprises an agitator and the controller is configured to control the operation of the agitator.

16. The apparatus of claim 1, wherein the second dispensing apparatus is one of a pump and a valve.

17. An apparatus for preparing infant formula, comprising:
a first chamber comprising a first opening;
a first compartment comprising a second opening and a dispensing apparatus that is configured to dispense a measured amount of a first mixing ingredient from the first compartment into the first chamber, the first compartment comprising:
a scoop with a void configured to receive a volume of the first mixing ingredient, wherein the scoop void is configured to move the volume between the first opening and the second opening.

18. The apparatus of claim 17, the dispensing apparatus further comprising a cam that is configured to position the scoop.

19. The apparatus of claim 18, the dispensing apparatus further comprising means for biasing the scoop against the cam.

20. The apparatus of claim 17, the dispensing apparatus further comprising an arm that is configured to fill the scoop with the first mixing ingredient.
